(19) United States
(12) Patent Application Publication
(10) Pub. No.: US 2026/0365134 A1
(43) Pub. Date: Nov. 19, 2026

(54) AIRBAG APPARATUS WITH VARIABLE VOLUME

(71) Applicant: HYUNDAI MOBIS CO., LTD., Seoul (KR)

(72) Inventors: Byung Gu KANG, Yongin-si (KR); Jae Hyun KIM, Yongin-si (KR)

(73) Assignee: HYUNDAI MOBIS CO., LTD., Seoul (KR)

(21) Appl. No.: 19/671,510

(22) Filed: May 8, 2026

(30) Foreign Application Priority Data
May 15, 2025 (KR) 10-2025-0063268

(51) Int. Cl. B60R 21/2334; B60R 21/013; B60R 21/235; B60R 21/26; B60R 21/231

(52) U.S. Cl. CPC B60R 21/2334; B60R 21/013; B60R 21/235; B60R 21/26; B60R 2021/23123; B60R 2021/23538

(57) ABSTRACT

An airbag apparatus with variable volume, the airbag apparatus comprises an airbag housing, an airbag cushion having a plurality of stitched panels, the airbag cushion being folded and accommodated in the airbag housing and configured to be inflated by gas injection and to protrude from the airbag housing, a flexible tube fixed to an inner surface of the airbag cushion, a strap including an intermediate portion inserted into the flexible tube, a first portion connected to a first side of the intermediate portion, extending from a first side of the flexible tube, and protruding outward from the airbag cushion, and a second portion connected to a second side of the intermediate portion, extending from a second side of the flexible tube, and connected to the first portion, and a strap release device selectively connected to the first portion of the strap outside the airbag cushion.

### CROSS-REFERENCE TO RELATED APPLICATIONS

The present application claims priority and the benefit of Korean Patent Application No. 10-2025-0063268, filed on May 15, 2025, in the Korean Intellectual Property Office, the entire disclosure of which is incorporated herein by reference.

### TECHNICAL FIELD

The present disclosure relates to an airbag apparatus with variable volume, and more particularly, to an airbag apparatus with variable volume in which a volume of an airbag cushion varies depending on whether a seat belt is fastened.

### BACKGROUND

A driver-side airbag apparatus is mounted on a steering wheel positioned in front of a driver seat. In the event of a vehicle collision, an airbag cushion protrudes from the steering wheel toward the driver seat and inflates to protect the driver from impact.

In the event of a vehicle collision with the seat belt unfastened, the airbag cushion is required to inflate sufficiently to prevent the driver from being displaced from the driver seat or ejected from the vehicle.

However, in the event of a vehicle collision with the seat belt fastened, if the airbag cushion inflates excessively, the driver may sustain chest injuries from the airbag cushion. Therefore, the airbag cushion is required to inflate to a reduced volume when the seat belt is fastened, compared to when the seat belt is unfastened.

The related art of the present disclosure is disclosed in Korean Patent No. 10-0778578 (registered on Nov. 15, 2007, and entitled “The air bag device for vehicle in which the auxiliary chamber is equipped”).

### SUMMARY

Various aspects of the present disclosure are directed to providing an airbag apparatus with variable volume, in which a deployed airbag cushion has a larger volume in the event of a vehicle collision with a seat belt unfastened than in the event of a vehicle collision with the seat belt fastened.

An airbag apparatus with variable volume according to the present disclosure includes an airbag housing, an airbag cushion having a plurality of stitched panels, the airbag cushion being folded and accommodated in the airbag housing and configured to be inflated by gas injection and to protrude from the airbag housing, a flexible tube fixed to an inner surface of the airbag cushion, a strap including an intermediate portion inserted into the flexible tube, a first portion connected to a first side of the intermediate portion, extending out of a first side of the flexible tube, and protruding outward from the airbag cushion, and a second portion connected to a second side of the intermediate portion, extending from a second side of the flexible tube, and connected to the first portion, and a strap release device selectively connected to the first portion of the strap outside the airbag cushion.

The airbag housing may be positioned in front of a vehicle seat. The strap release device may be connected to the first portion of the strap with a buckle of a seat belt of the seat fastened. The strap may be disconnected from the strap release device with the buckle of the seat belt of the seat unfastened. The airbag cushion inflated with the strap release device connected to the first portion of the strap may have a smaller volume than the airbag cushion inflated with the strap released from the strap release device.

The airbag housing may be installed on a steering wheel of the vehicle.

The strap release device may be installed in the airbag housing.

The flexible tube may be positioned at a height equal to or lower than a height of a center of the airbag cushion.

An angle, defined with respect to the center of the airbag cushion, between one end and an opposite end of the flexible tube may be in a range between about 90° to about 180°.

The second portion of the strap may have a loop. The first portion of the strap may pass through the loop and protrude outward from the airbag cushion.

The airbag cushion may include a rear panel having a first outer peripheral portion, and a front panel having a second outer peripheral portion coupled to the first outer peripheral portion. The flexible tube may be fixed to the first outer peripheral portion and the second outer peripheral portion by stitching.

The flexible tube may have a flexible tube panel bent such that widthwise opposing end portions face each other, the widthwise opposing end portions being fixed to the first outer peripheral portion and the second outer peripheral portion by stitching.

The second portion of the strap may be fixed to the rear panel.

The airbag apparatus with variable volume may further include an inflator configured to be actuated in a vehicle collision to supply gas into an interior of the airbag cushion. The rear panel may have an inflator through-hole into which the inflator is inserted, and a strap through-hole through which the first portion of the strap passes.

The airbag cushion may further include a first heat shield having a heat shield through-hole aligned with the strap through-hole, the first heat shield overlapping the rear panel and facing an inner surface of the rear panel, and a second heat shield overlapping the first heat shield and facing an inner surface of the first heat shield. The first portion of the strap may pass between the first heat shield and the second heat shield, pass through the heat shield through-hole and the strap through-hole, and protrude outward from the airbag cushion.

The first heat shield and the second heat shield may be coupled to the rear panel by stitching, and the strap may not be fixed to the rear panel, the first heat shield, or the second heat shield.

The airbag cushion may further include an internal tether having one end portion fixed to an inner surface of the front panel and an opposite end portion fixed to an inner surface of the rear panel.

In the airbag apparatus with variable volume, the airbag cushion inflates to a larger volume when the seat belt is unfastened than when the seat belt is fastened in the event of a vehicle collision.

Accordingly, in the event of a vehicle collision when an occupant’s seat belt is unfastened, the occupant may be protected such that impact is mitigated, and displacement of the occupant from the driver seat or ejection from the vehicle is prevented. When an occupant’s seat belt is fastened, the occupant's chest injury caused by the deployed airbag cushion may be prevented.

The airbag apparatus with variable volume, when applied to a driver-side airbag, enables high safety ratings in vehicle safety tests conducted by countries or regions that assign vehicle safety ratings by distinguishing between belted and unbelted driver scenarios.

### BRIEF DESCRIPTION OF THE DRAWINGS

FIG. 1 is a longitudinal sectional view of an airbag apparatus with variable volume according to an embodiment of the present disclosure.

FIG. 2 is a front view illustrating the interior of an airbag cushion when the airbag cushion of FIG. 1 is deployed with a strap released from a strap release device, in which the airbag cushion and a flexible tube are shown in dashed lines and the strap, the strap release device, and an inflator are shown in solid lines.

FIG. 3 is a front view illustrating the interior of the airbag cushion when the airbag cushion is deployed with the strap of FIG. 1 connected to the strap release device, in which the airbag cushion and the flexible tube are shown in dashed lines, and the strap, strap release device, and inflator are shown in solid lines.

FIG. 4 is an enlarged view of portion A of FIG. 2.

FIG. 5 is a longitudinal sectional view illustrating the airbag cushion and the interior of the airbag cushion when the airbag cushion of FIG. 1 is deployed with the strap released from the strap release device.

FIG. 6 is an enlarged view of portion B of FIG. 5.

FIG. 7 is an enlarged view of portion C of FIG. 5.

### DETAILED DESCRIPTION

An airbag apparatus with variable volume according to embodiments of the present disclosure will be described below with reference to the accompanying drawings. The terminology used herein is intended to appropriately describe embodiments of the present disclosure, and may vary depending on the intentions of the user or operator or the conventions of the field to which the present disclosure pertains. Therefore, the definition of the terminology should be made according to the overall disclosure set forth herein.

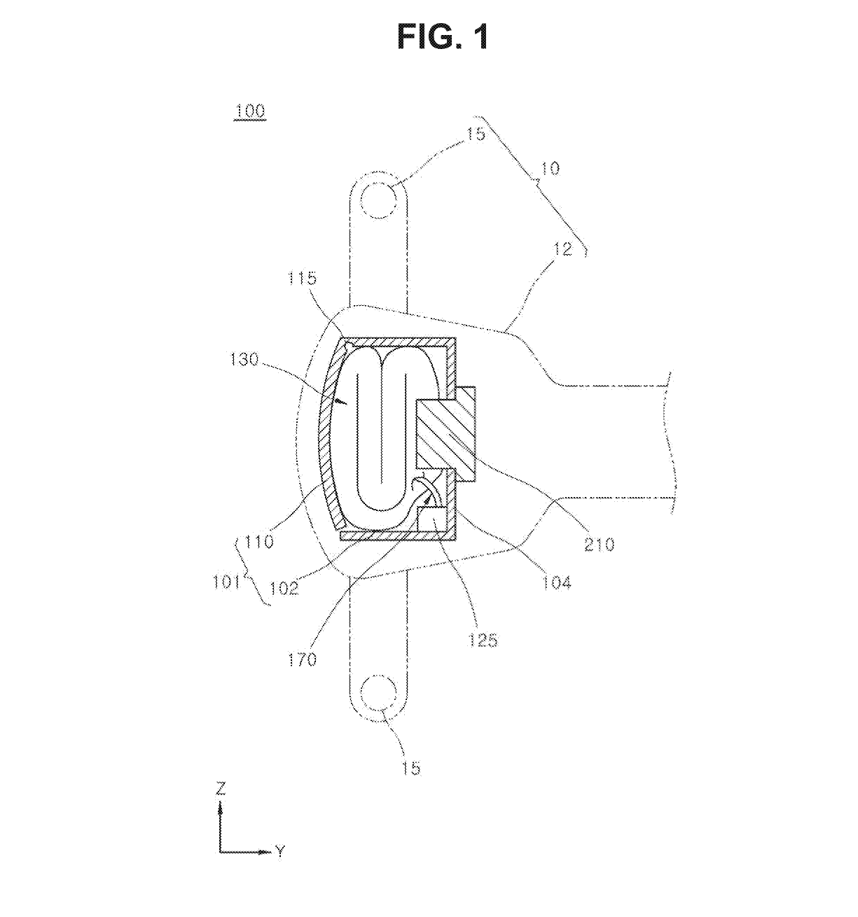

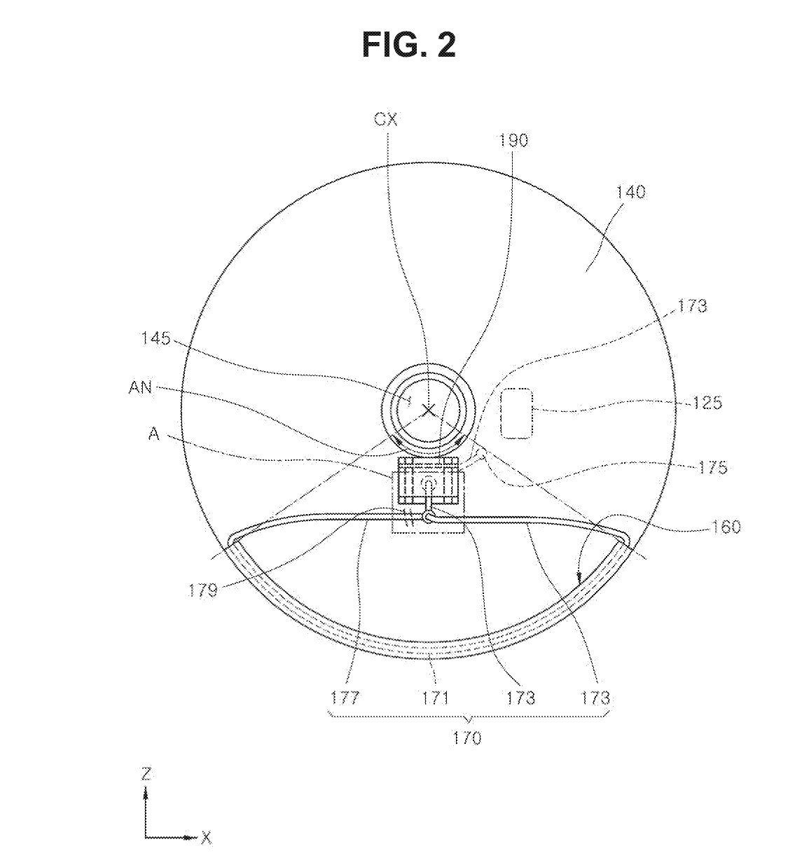

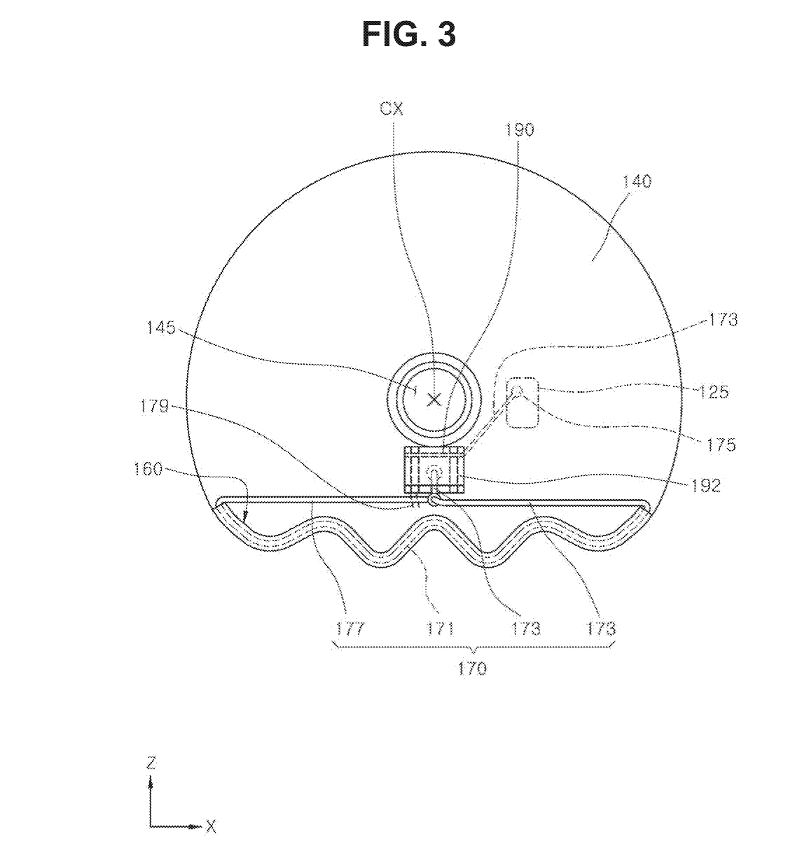

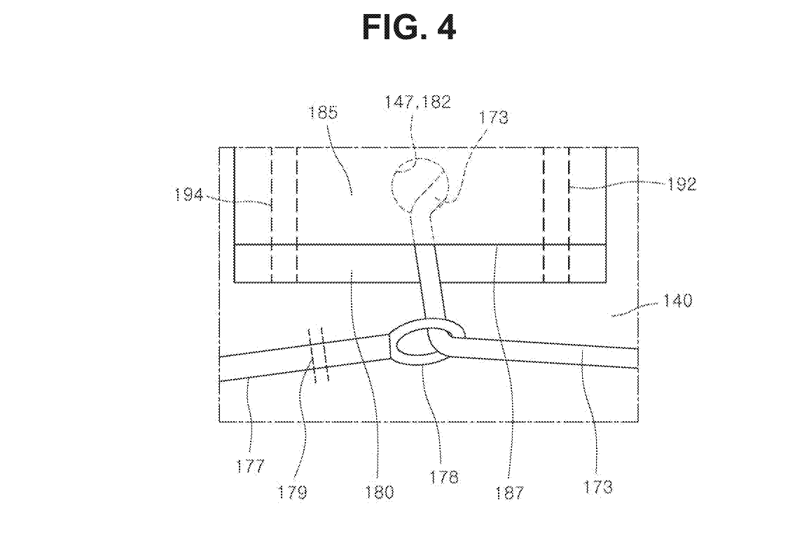

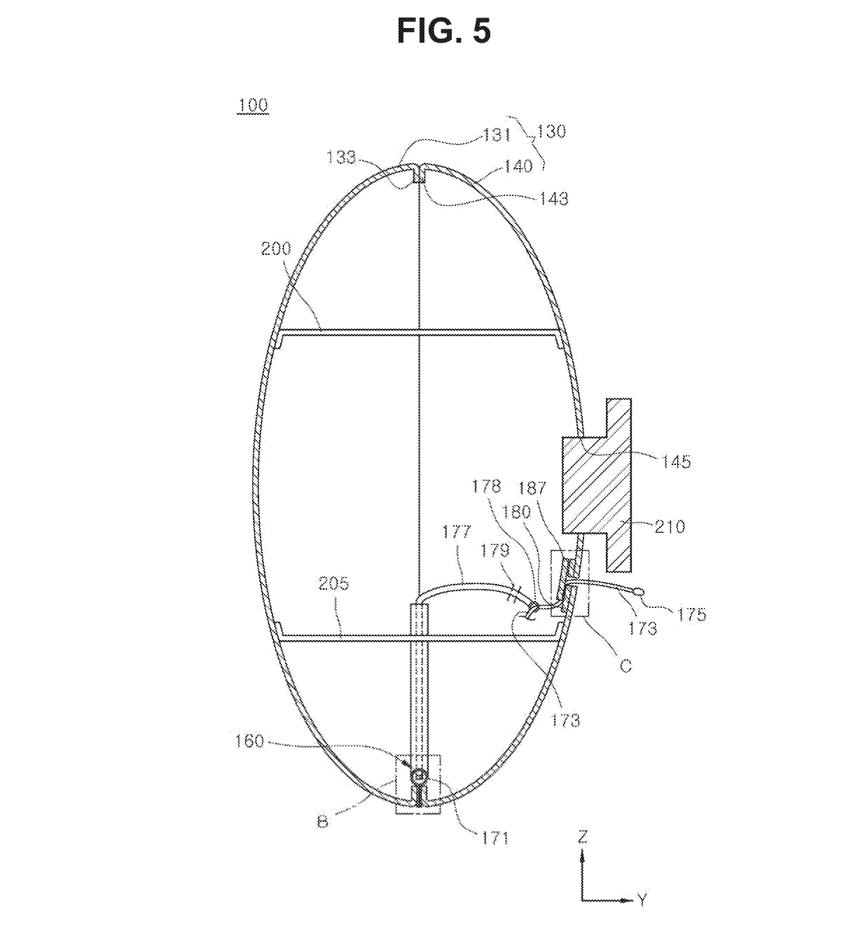

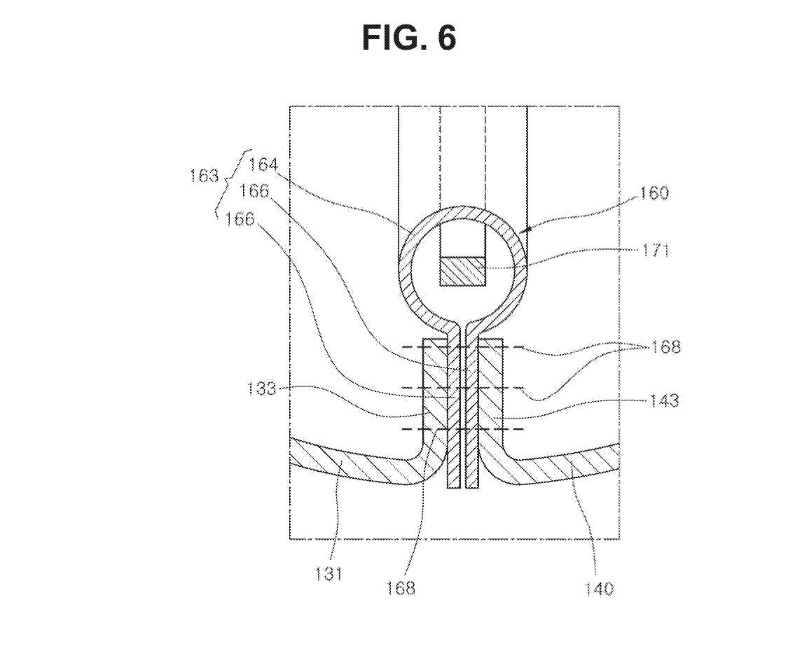

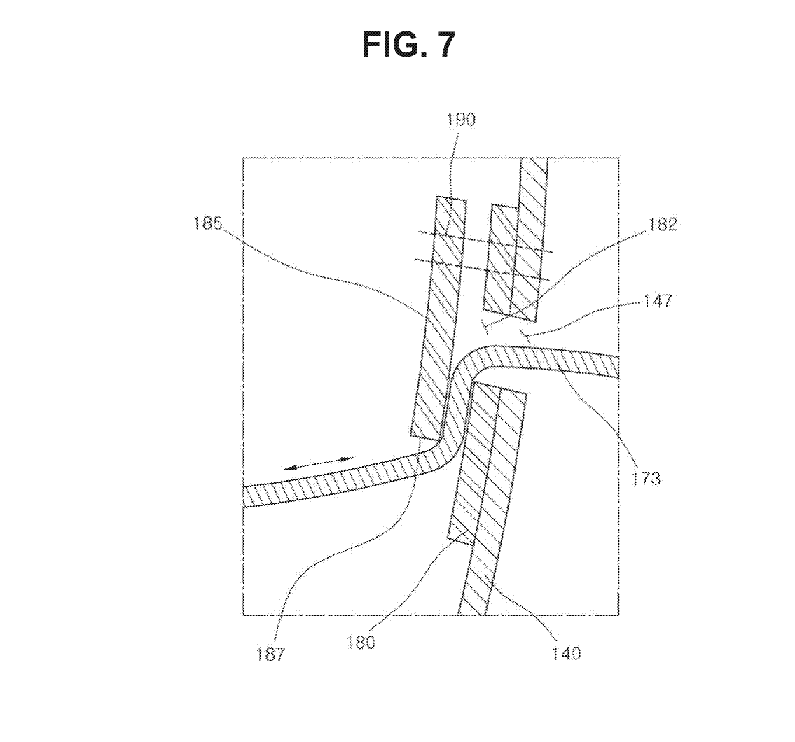

FIG. 1 is a longitudinal sectional view of an airbag apparatus with variable volume according to an embodiment of the present disclosure. FIG. 2 is a front view illustrating the interior of an airbag cushion when the airbag cushion of FIG. 1 is deployed with a strap released from a strap release device, in which the airbag cushion and a flexible tube are shown in dashed lines and the strap, the strap release device, and an inflator are shown in solid lines. FIG. 3 is a front view illustrating the interior of the airbag cushion when the airbag cushion is deployed with the strap of FIG. 1 connected to the strap release device, in which the airbag cushion and the flexible tube are shown in dashed lines, and the strap, strap release device, and inflator are shown in solid lines. FIG. 4 is an enlarged view of portion A of FIG. 2. FIG. 5 is a longitudinal sectional view illustrating the airbag cushion and the interior of the airbag cushion when the airbag cushion of FIG. 1 is deployed with the strap released from the strap release device. FIG. 6 is an enlarged view of portion B of FIG. 5. FIG. 7 is an enlarged view of portion C of FIG. 5.

Referring to FIGS. 1-7, an airbag apparatus 100 with variable volume according to an embodiment of the present disclosure includes an airbag housing 101, an airbag cushion 130, a flexible tube 160, a strap 170, and a strap release device 125. The airbag apparatus 100 with variable volume may function as a driver-side airbag apparatus to protect a driver in the event of a vehicle collision.

A vehicle steering wheel 10 may include a wheel hub 12 connected to a steering shaft (not illustrated) and a wheel rim 15 connected to the wheel hub 12 by spokes (not illustrated), which is a hand-gripped portion by the driver.

For example, the airbag housing 101 may be positioned in front of the driver seat and mounted to the wheel hub 12. The airbag housing 101 may include a base 102 and a cover 110. The base 102 provides an internal space for accommodating the folded airbag cushion 130 and the strap release device 125. One side (or the first side) of the base 102 facing the driver seat is open.

The cover 110 may close the open side of the base 102 and be coupled to the base 102 via a hinge 115.

As illustrated in FIG. 1, the airbag cushion 130 is folded and accommodated in the airbag housing 101. Specifically, the airbag cushion 130 may be accommodated in the internal space of the base 102. In response to gas being injected into the airbag cushion 130, as illustrated in FIG. 5, the airbag cushion 130 may expand, deploy, and protrude from the airbag housing 101.

The airbag apparatus 100 with variable volume may further include an inflator 210 configured to be activated to supply gas into the interior of the airbag cushion 130 in the event of a vehicle collision.

In response to gas being rapidly injected into the interior of the airbag cushion 130 from the inflator 210, the cover 110 pivots about the hinge 115 due to the expansion pressure of the airbag cushion 130, which causes one side (or the first side) of the base 102 facing the driver seat to open, and the airbag cushion 130 protrudes toward the driver seated in the driver seat.

The airbag cushion 130 includes a plurality of panels 131 and 140 coupled by stitching. For example, the airbag cushion 130 may include a rear panel 140 having a first outer peripheral portion 143 and a front panel 131 having a second outer peripheral portion 133 coupled to the first outer peripheral portion 143 by stitching. The planar shapes of the rear panel 140 and the front panel 131 may, for example, be circular.

The rear panel 140 may include an inflator through-hole 145 into which the inflator 210 is inserted. The inflator through-hole 145 may be formed at the center CX of the airbag cushion 130. The inflator 210 passes through the bottom plate 104 and is installed in the base 102, inserted into the inflator through-hole 145, and fixed to the rear panel 140.

The flexible tube 160 is fixed to the inner surface of the airbag cushion 130. The flexible tube 160 may include a flexible tube panel 163 having a middle portion 164 and a pair of end portions 166 on both sides of the middle portion 164.

The flexible tube 160 may be fixed to the first outer peripheral portion 143 and the second outer peripheral portion 133 by stitching. The middle portion 164 may be bent such that the widthwise opposing end portions 166 face each other, and the opposing end portions 166 may be fixed to the first outer peripheral portion 143 and the second outer peripheral portion 133 by stitching, thereby forming the flexible tube 160.

The opposing end portions 166 of the tube panel 163 are coupled to the first outer peripheral portion 143 and the second outer peripheral portion 133 by a stitched portion 168, so that the middle portion 164 of the tube panel 163 has a closed-loop cross-section and may form a tube having a longitudinally extending hollow.

For example, the flexible tube 160 may extend along the first outer peripheral portion 143 and the second outer peripheral portion 133. Alternatively, the flexible tube 160 may extend along the circumferential direction of the center CX of the airbag cushion 130.

The strap 170 includes an intermediate portion 171, a first portion 173, and a second portion 177. The intermediate portion 171 may be the portion inserted into the flexible tube 160. The first portion 173 is connected to one side (or the first side) of the intermediate portion 171, extends to a longitudinal end of the flexible tube 160, and protrudes outward from the airbag cushion 130. The second portion 177 is connected to an opposite side (or the second side) of the intermediate portion 171, extends to an opposite longitudinal end of the flexible tube 160, and is connected to the first portion 173.

Referring to FIGS. 2-4, the second portion 177 of the strap 170 may include a loop 178 at the end portion. The first portion 173 of the strap 170 may pass through the loop 178 of the second portion 177 and protrude outward from the airbag cushion 130.

The rear panel 140 may have a strap through-hole 147 through which the first portion 173 of the strap 170 passes. The strap through-hole 147 may be positioned lower than the inflator through-hole 145.

The second portion 177 of the strap 170 may be fixed to the rear panel 140 by stitching. For example, a portion of the second portion 177 may be fixed to the rear panel 140 by a stitched portion 179.

The strap release device 125 may be selectively connected to the first portion 173 of the strap 170 outside the airbag cushion 130. In other words, the strap release device 125 is configured to connect to and release from the first portion 173 of the strap 170. The strap release device 125 may be installed on the base 102.

For example, the first portion 173 of the strap 170 may include a loop 175 at the end portion. The loop 175 of the first portion 173 may be releasably connected to the strap release device 125.

With a buckle (not illustrated) of a seat belt of the driver seat fastened, the strap release device 125 is connected to the first portion 173 of the strap 170. With the buckle of the seat belt of the driver seat unfastened, the strap 170 may be disconnected from the strap release device 125.

For example, with the buckle of the seat belt described above fastened, the loop 175 of the first portion 173 is connected to the strap release device 125, and with the buckle of the seat belt described above unfastened, the loop 175 of the first portion 173 is disengaged from the strap release device 125.

For example, an electronic control unit (ECU) of a vehicle may identify whether the buckle of the seat belt is fastened based on a signal received from a sensor (not illustrated) installed in the buckle of the seat belt of the driver seat. If the buckle of the seat belt is fastened, the ECU controls an operation such that the strap release device 125 engages the loop 175 of the first portion 173. If the buckle of the seat belt is unfastened, the ECU controls an operation such that the strap release device 125 does not engage the loop 175 of the first portion 173.

In the event of a vehicle collision with the buckle of the seat belt of the driver seat fastened, the inflator 210 is activated to inflate the airbag cushion 130 with the strap release device 125 connected to the loop 175 of the first portion 173 of the strap 170.

In the event of a vehicle collision with the buckle of the seat belt of the driver seat unfastened, the airbag cushion 130 is inflated with the strap 170 released from the strap release device 125.

As illustrated in FIG. 3, in response to gas being injected into the airbag cushion 130 with the strap release device 125 connected to the strap 170, a gap between the loop 175 of the first portion 173 and the loop 178 of the second portion 177 increases as the airbag cushion 130 deploys. Accordingly, the flexible tube 160 may be bent into a wave shape such that a straight-line distance between one end and an opposite end of the flexible tube 160 is reduced.

Therefore, the airbag cushion 130 inflated with the strap release device 125 connected to the first portion 173 of the strap 170 (see FIG. 3) has a smaller volume than the airbag cushion 130 inflated with the strap 170 released from the strap release device 125 (see FIG. 2).

As a result, in the event of a vehicle collision with the seat belt of the driver seat unfastened, the driver may be protected such that impact is mitigated, and displacement of the driver from the driver seat or ejection from the vehicle is prevented. With the seat belt fastened, the driver's chest injury caused by the deployed airbag cushion 130 may be prevented.

The flexible tube 160 may be positioned at a height equal to or lower than that of a center CX of the airbag cushion 130. An angle AN, defined with respect to the center CX of the airbag cushion 130, between one end and an opposite end of the flexible tube 160 may be in a range between about 90° and about 180°. If the flexible tube 160 is positioned above the center CX of the airbag cushion 130, a volume of the inflated airbag cushion 130 may be reduced, but a risk of chest injury to the driver with the seat belt of the driver seat fastened may not be reduced.

The airbag apparatus 100 with variable volume may further include a first internal tether 200 and a second internal tether 205. One end portion of the first internal tether 200 may be fixed to an inner surface of the front panel 131, and an opposite end portion of the first internal tether 200 may be fixed to an inner surface of the rear panel 140. One end portion of the second internal tether 205 may be fixed to an inner surface of the front panel 131, and an opposite end portion of the second internal tether 205 may be fixed to an inner surface of the rear panel 140.

The first internal tether 200 may be positioned above the second internal tether 205. For example, if the airbag cushion 130 is deployed, the first internal tether 200 may be positioned above the center CX of the airbag cushion 130, and the second internal tether 205 may be positioned below the center CX of the airbag cushion 130.

If the first internal tether 200 and the second internal tether 205 are absent, the airbag cushion 130 may become excessively thick in a thickness direction, i.e., in a Y-axis direction with reference to FIG. 5, and may fail to deploy to an optimal size in a radial direction.

An airbag apparatus with variable volume according to another embodiment of the present disclosure may include one internal tether or may include three or more internal tethers.

The strap 170 may have lower elasticity and higher rigidity than the internal tethers 200 and 205. If the strap 170 stretches easily, the deployed airbag cushion 130 with the strap release device 125 and the strap 170 connected may not have a substantially smaller volume than the deployed airbag cushion 130 with the strap 170 released from the strap release device 125.

With reference to FIGS. 2-5 and 7, the airbag cushion 130 may further include a first heat shield 180 and a second heat shield 185.

The first heat shield 180 may overlap the rear panel 140 and face an inner surface of the rear panel 140. The first heat shield 180 may include a heat shield through-hole 182 aligned with the strap through-hole 147. The second heat shield 185 may overlap the first heat shield 180 and face an inner surface of the first heat shield 180.

In a folded state of the airbag cushion 130 as illustrated in FIG. 1, the overlapping first heat shield 180 and second heat shield 185 may be positioned to face the inflator 210. Accordingly, the rear panel 140 may not be damaged by heat when the inflator 210 is activated.

The first portion 173 of the strap 170 may pass between the first heat shield 180 and the second heat shield 185, pass through the heat shield through-hole 182 and the strap through-hole 147, and protrude outward from the airbag cushion 130.

The first heat shield 180 and the second heat shield 185 may be coupled to the rear panel 140 by stitching. The strap 170 may not be fixed to the rear panel 140, the first heat shield 180, or the second heat shield 185.

For example, the second heat shield 185 may have a smaller size than the first heat shield 180. For example, the first portion 173 of the strap 170 may pass between spaced ends of the first heat shield 180 and the second heat shield 185, pass through the heat shield through-hole 182 and the strap through-hole 147, and protrude outward from the airbag cushion 130.

The first heat shield 180 and the second heat shield 185 may be coupled to the rear panel 140 by a first stitched portion 190, a second stitched portion 192, and a third stitched portion 194. For example, the first stitched portion 190 may extend in a horizontal direction, i.e., an X-axis direction, between the heat shield through-hole 182 and the inflator through-hole 145.

The second stitched portion 192 may be formed on a portion spaced apart from the heat shield through-hole 182 toward one side (or the first side) and may extend in a vertical direction, i.e., a Z-axis direction. The second stitched portion 192 may intersect the first stitched portion 190.

The third stitched portion 194 may be formed on a portion spaced apart from the heat shield through-hole 182 toward an opposite side (or the second side) and may extend in a vertical direction, i.e., a Z-axis direction. The third stitched portion 194 may intersect the first stitched portion 190.

Through a gap between the first heat shield 180 and the second heat shield 185, where entry into the heat shield through-hole 182 is not blocked by the first stitched portion 190, the second stitched portion 192, or the third stitched portion 194, the first portion 173 of the strap 170 may pass between the overlapping first heat shield 180 and second heat shield 185, pass through the heat shield through-hole 182 and the strap through-hole 147, and protrude outward from the airbag cushion 130.

Although the present disclosure has been described with reference to an embodiment illustrated in the drawings, this is merely exemplary, and those skilled in the art will understand that various modifications and other equivalent embodiments can be made from this embodiment. Accordingly, the true scope of the present disclosure should be defined only by the appended claims.

What is claimed is:

1. An airbag apparatus with variable volume, comprising:
an airbag housing;
an airbag cushion having a plurality of stitched panels, the airbag cushion being folded and accommodated in the airbag housing and configured to protrude from the airbag housing when inflated by gas injection;
a flexible tube fixed to an inner surface of the airbag cushion;
a strap including:
an intermediate portion inserted into the flexible tube;
a first portion connected to a first side of the intermediate portion, extending from a first side of the flexible tube, and protruding outward from the airbag cushion; and
a second portion connected to a second side of the intermediate portion, extending from a second side of the flexible tube, and connected to the first portion; and
a strap release device selectively connected to the first portion of the strap outside the airbag cushion.

2. The airbag apparatus of claim 1, wherein:
the airbag housing is positioned in front of a vehicle seat,
the strap release device is connected to the first portion of the strap with a buckle of a seat belt of the vehicle seat fastened,
the strap is disconnected from the strap release device with the buckle of the seat belt of the vehicle seat unfastened, and
the airbag cushion inflated with the strap release device connected to the first portion of the strap has a volume smaller than that of the airbag cushion inflated with the strap released from the strap release device.

3. The airbag apparatus of claim 2, wherein the flexible tube is positioned at a height equal to or lower than that of a center of the airbag cushion.

4. The airbag apparatus of claim 3, wherein an angle, defined with respect to the center of the airbag cushion, between one end and an opposite end of the flexible tube is in a range between about 90° and about 180°.

5. The airbag apparatus of claim 1, wherein:
the second portion of the strap has a loop, and
the first portion of the strap passes through the loop and protrudes outward from the airbag cushion.

6. The airbag apparatus of claim 1, wherein:
the airbag cushion includes a rear panel having a first outer peripheral portion and a front panel having a second outer peripheral portion coupled to the first outer peripheral portion, and
the flexible tube is fixed to the first outer peripheral portion and the second outer peripheral portion by stitching.

7. The airbag apparatus of claim 6, wherein the flexible tube has a flexible tube panel bent such that widthwise opposing end portions face each other, the widthwise opposing end portions being fixed to the first outer peripheral portion and the second outer peripheral portion by stitching.

8. The airbag apparatus of claim 6, further comprising an inflator configured to be activated in a vehicle collision to supply gas into an interior of the airbag cushion,
wherein the rear panel comprises:
an inflator through-hole into which the inflator is inserted, and
a strap through-hole through which the first portion of the strap passes.

9. The airbag apparatus of claim 8, wherein the airbag cushion further includes:
a first heat shield having a heat shield through-hole aligned with the strap through-hole, the first heat shield overlapping the rear panel and facing an inner surface of the rear panel, and
a second heat shield overlapping the first heat shield and facing an inner surface of the first heat shield,
wherein the first portion of the strap passes between the first heat shield and the second heat shield, passes through the heat shield through-hole and the strap through-hole, and protrudes outward from the airbag cushion.

10. The airbag apparatus of claim 9, wherein:
the first heat shield and the second heat shield are coupled to the rear panel by stitching, and
the strap is not fixed to the rear panel, the first heat shield, or the second heat shield.
